(19) United States
(12) Patent Application Publication
(10) Pub. No.: US 2014/0074472 A1
(43) Pub. Date: Mar. 13, 2014

(54) VOICE CONTROL SYSTEM WITH PORTABLE VOICE CONTROL DEVICE

(71) Applicants: Chih-Hung Lin, Taichung City (TW); Teh-Jang Chen, Taichung City (TW)

(72) Inventors: Chih-Hung Lin, Taichung City (TW); Teh-Jang Chen, Taichung City (TW)

(21) Appl. No.: 13/611,684

(22) Filed: Sep. 12, 2012

(51) Int. Cl. G10L 15/00

(52) U.S. Cl. 704/246; 704/E15.001

(57) ABSTRACT

A voice control system is adapted for controlling an electrical appliance, and includes a host and a portable voice control device. The portable voice control device is capable of wireless communication with the host, and includes an audio pick-up unit for receiving a voice input. One of the host and the portable voice control device includes a voice recognition control module that is configured to recognize a control command from the voice input. The host controls operation of the electrical appliance according to the control command, and transmits an appliance status message to the portable voice control device. The portable voice control device further includes an output unit for outputting the appliance status message.

### BACKGROUND OF THE INVENTION

1. Field of the Invention

The present invention relates to a voice control system, more particularly to a voice control system with a portable voice control device for controlling operation of an electrical appliance.

2. Description of the Related Art

Traditionally, when people intend to control operation of electrical appliances at home, such as a television, a refrigerator, a microwave oven, an electric light, etc., either a method of direct contact operation using one's hand, such as pushing a button or turning a knob, or a method of remote control, such as manipulating a remote controller to turn on and off a television, is required for achieving operation control of the electrical appliances.

However, for the former method, an operator needs to move to the electrical appliance for performing the direct contact operation such that the operator may not handle multiple tasks at the same time. For the latter method, in general, each of the electrical appliances is provided with a corresponding remote controller so that different kinds of remote controllers may usually be found in a household. Therefore, confusion when using the remote controllers often occurs, and a situation that the operator cannot find the correct remote controller to control operation of the corresponding electrical appliance frequently happens.

### SUMMARY OF THE INVENTION

Therefore, an object of the present invention is to provide a voice control system with a portable voice control device which may facilitate control of multiple electrical appliances.

Accordingly, the voice control system of the present invention is adapted for controlling an electrical appliance. The voice control system comprises a host and a portable voice control device.

The portable voice control device is capable of wireless communication with the host and includes at least one audio pick-up unit for receiving a voice input.

One of the host and the portable voice control device includes a voice recognition control module that is configured to recognize a control command from the voice input received by the audio pick-up unit;

The host is to be connected to the electrical appliance, is configured to control operation of the electrical appliance according to the control command, and is further configured to transmit an appliance status message to the portable voice control device.

The portable voice control device further includes an output unit for outputting the appliance status message.

An effect of the present invention resides in that, by means of a design of the portable voice control device in cooperation with the host, a user may control operation of different kinds of electrical appliances by utilizing voice control so as to effectively promote user convenience.

### BRIEF DESCRIPTION OF THE DRAWINGS

Other features and advantages of the present invention will become apparent in the following detailed description of two preferred embodiments with reference to the accompanying drawings, of which:

FIG. 1 is a block diagram of a first preferred embodiment of a voice control system according to the present invention;

FIG. 2 is a perspective view of the first preferred embodiment; and

FIG. 3 is a perspective view of a second preferred embodiment of the voice control system according to the present invention.

### DETAILED DESCRIPTION OF THE PREFERRED EMBODIMENTS

Before the present invention is described in greater detail with reference to the preferred embodiments, it should be noted that the same reference numerals are used to denote the same elements throughout the following description.

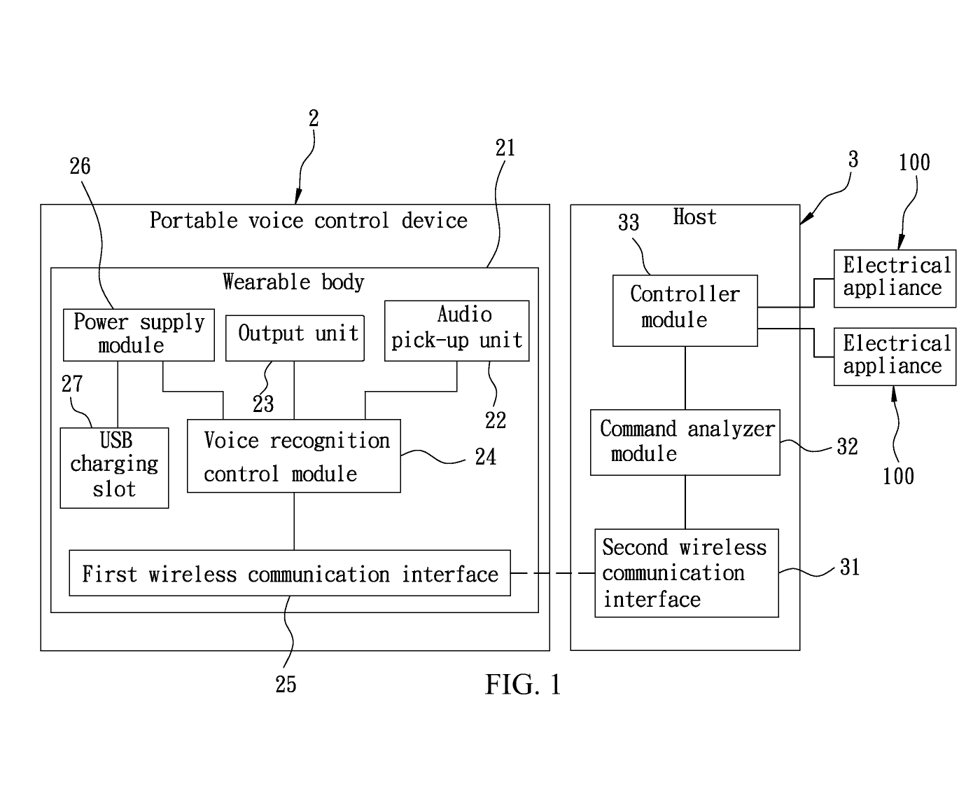

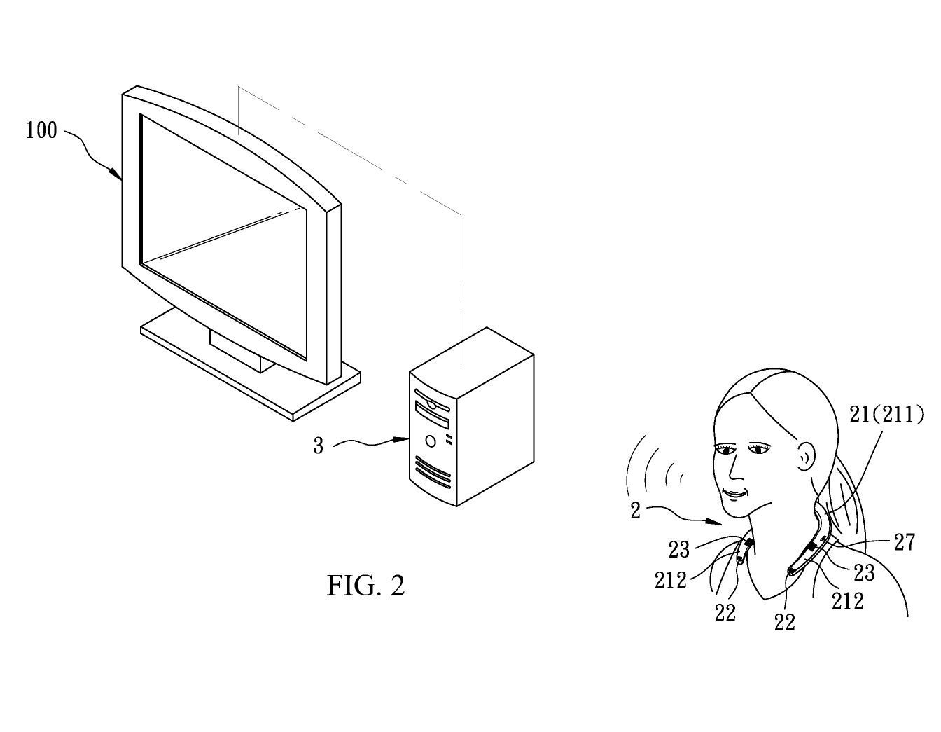

Referring to FIG. 1 and FIG. 2, a first preferred embodiment of a voice control system according to the present is adapted for controlling at least one electrical appliance 100.

The first preferred embodiment of the voice control system comprises a host 3 and a portable voice control device 2.

The portable voice control device 2 is capable of wireless communication with the host 3. The portable voice control device 2 includes a wearable body 21 which maybe removably hung on a human body, at least one audio pick-up unit 22 disposed on the wearable body 21 for receiving a voice input, an output unit 23 disposed on the wearable body 21, a voice recognition control module 24 disposed in the wearable body 21 and electrically coupled to the audio pick-up unit 22 and the output unit 23, a first wireless communication interface 25 electrically coupled to the voice recognition control module 24, a power supply module 26 disposed in the wearable body 21 for providing power to at least the voice recognition control module 24, and a universal serial bus (USB) charging slot 27 disposed on the wearable body 21 and coupled electrically to the power supply module 26 for enabling charging of the power supply module 26 via the USB charging slot 27.

In the first preferred embodiment, the at least one audio pick-up unit 22 is two in number, and are preferably two microphones . The output unit 23 includes two speakers . The wearable body 21 is substantially U-shaped, and includes a curved segment 211 for hanging on a neck of the human body and a pair of extending segments 212 extending from two opposite ends of the curved segment 211. Each of the audio pick-up units 22 is disposed at a distal end of a respective one of the extending segments 212 distal from the curved segment 211, and faces the other one of the audio pick-up units 22. Each of the speakers is disposed on the curved segment 211 and faces the other one of the speakers.

The first wireless communication interface 25 adopts Bluetooth technology for communication in this embodiment. However, in practice, the first wireless communication interface 25 maybe implemented using one of WiFi, Near Field Communication (NFC), and radio frequency identification (RFID) technologies.

The host 3 is to be connected to the electrical appliance 100, and is configured to control operation of the electrical appliance 100. The connection between the host 3 and the electrical appliance 100 may be implemented through one of wired and wireless communication. Nevertheless, since the feature of the present invention does not reside in the connection scheme therebetween, further details of the same are omitted herein.

The host 3 includes a second wireless communication interface 31 for communicating with the portable voice control device 2 via the first wireless communication interface 25, a command analyzer module 32 electrically coupled to the second wireless communication interface 31, and a controller module 33. The controller module 33 is coupled electrically to the command analyzer module 32, is to be connected to the electrical appliance 100, and is configured to control operation of the electrical appliance 100. The second wireless communication interface 31 adopts Bluetooth technology for communication in this embodiment. However, in practice, the second wireless communication interface 31 may be implemented using one of WiFi, NFC, and RFID technologies.

In use, when the user utters a voice command, the voice recognition control module 24 of the portable voice control device 2 is configured to recognize a control command from the voice input received by the audio pick-up unit 22, and is configured to convert the control command into a control signal that is transmitted to the host 3 via wireless communication between the first and second wireless communication interfaces 25, 31.

The command analyzer module 32 of the host 3 is configured to analyze the control signal received from the portable voice control device 2 so as to obtain the control command that is transmitted to the controller module 33. The controller module 33 is configured to control operation of the electrical appliance 100 according to the control command from the command analyzer module 32.

The host 3 is further configured to transmit an appliance status message to the portable voice control device 2. The speakers of the output unit 23 are controlled by the voice recognition control module 24 to output an audible indication of the appliance status message. For example, when the user utters “turn on the television”, the portable voice control device 2 transmits the control signal corresponding to the voice command to the host 3, and the host 3 controls activation of the television. Further, after the television is activated, the speakers of the output unit 23 of the portable voice control device 2 outputs the audio indication of “television activated” for informing the user that the television has been activated.

It is noted that implementation of output of the appliance status message is not limited to an audio form. The appliance status message may be outputted visually, such as a text indication displayed via a LCD of the output unit 23, or a light indication emitted via a LED of the output unit 23.

Furthermore, a benefit of the voice recognition control module 24 being included in the portable voice control device 2 resides in that the control signal converted from the recognized control command by the voice recognition control module 24 may have a standard format and may have a smaller bandwidth requirement compared to that when the voice input received by the audio pick-up unit 22 is transmitted to the host 3. Therefore, data throughput may be saved since only the control signal is transmitted and the voice input is not required to be transmitted to the host 3 for recognition. However, the disposition of the voice recognition control module 24 is not limited to the portable voice control device 2, and may be included in the host 3 according to different design considerations.

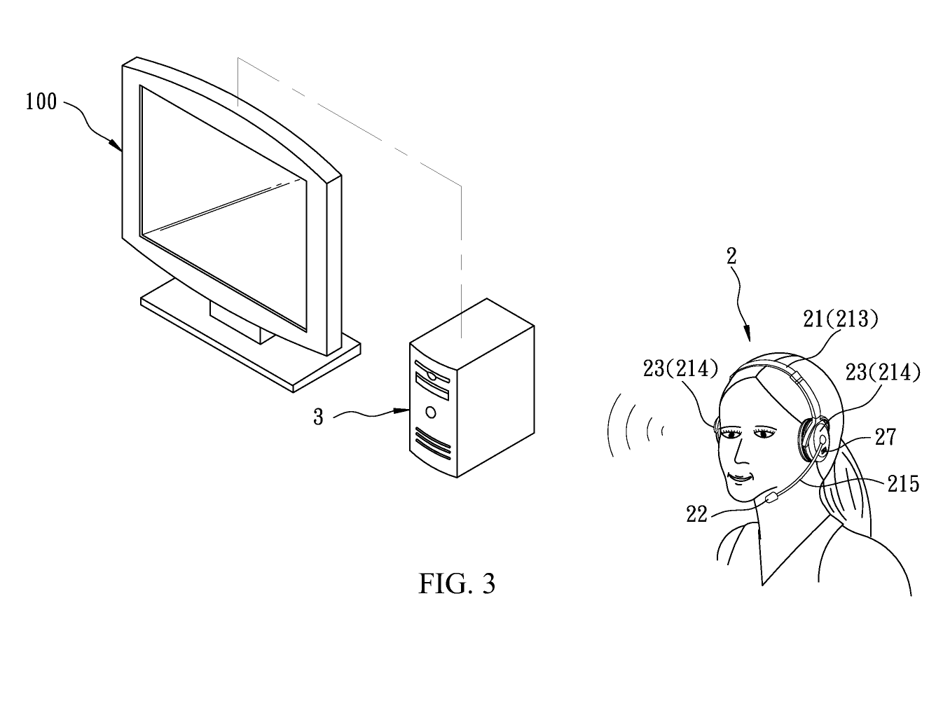

Referring to FIG. 1 and FIG. 3, a second preferred embodiment of the voice control system according to the present invention is substantially similar to the first preferred embodiment, and differs from the previous embodiment in the configuration of the portable voice control device 2. In this embodiment, the at least one audio pick-up unit 22 is one in number, and is preferably a microphone. The wearable body 21 includes a head support segment 213, a pair of ear segments 214 extending from two opposite ends of the head support segment 213, and an audio pickup holder 215 extending from one of the ear segments 214. The output unit 23 includes two speakers disposed respectively at the ear segments 214. The audio pick-up unit 22 is disposed at a distal end of the audio pickup holder 215.

It is noted that the actual shape of the portable voice control device 2 is not limited to the disclosures in the first and second preferred embodiments, and the portable voice control device 2 is not necessary to have a configuration that is wearable on the human body. For example, the portable voice control device 2 may have a configuration so as to be received in a pocket of clothing of the user.

To sum up, the voice control system of the present invention has the following advantages and effects:

1. By means of a design of the portable voice control device 2 in cooperation with the host 3, the user may control operation of the electrical appliances 100 by utilizing voice control so as to effectively promote user convenience.

2. Through the U-shaped design of the wearable body 21, the portable voice control device 2 may be hung on the neck of the user so as to enable the user to handle other tasks simultaneously when control of the electrical appliance 100.

In addition, it is noted that the portable voice control device 2 may be configured for wireless communication with an intercom system or a landline telephone (not shown) such that the user may answer the door or make a phone call via the portable voice control device 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A voice control system adapted for controlling an electrical appliance, said voice control system comprising:
a host; and
a portable voice control device which is capable of wireless communication with said host and which includes at least one audio pick-up unit for receiving a voice input;
wherein one of said host and said portable voice control device includes a voice recognition control module that is configured to recognize a control command from the voice input received by said audio pick-up unit;
wherein said host is to be connected to the electrical appliance, is configured to control operation of the electrical appliance according to the control command, and is further configured to transmit an appliance status message to said portable voice control device;
wherein said portable voice control device further includes an output unit for outputting the appliance status message.

2. The voice control system as claimed in claim 1, wherein said voice recognition control module is included in said portable voice control device and is configured to convert the control command into a control signal that is transmitted to said host;
said host being configured to control operation of the electrical appliance according to the control signal.

3. The voice control system as claimed in claim 2, wherein said output unit includes a speaker that is connected to and controlled by said voice recognition control module to output an audible indication of the appliance status message.

4. The voice control system as claimed in claim 2, wherein said host includes:
a command analyzer module configured to analyze the control signal received from said portable voice control device so as to obtain the control command; and
a controller module coupled electrically to said command analyzer module, to be connected to the electrical appliance, and configured to control operation of the electrical appliance according to the control command from said command analyzer module.

5. The voice control system as claimed in claim 1, wherein said portable voice control device further includes a first wireless communication interface, said host further includes a second wireless communication interface for communicating with said portable voice control device via said first wireless communication interface, and said first and second wireless communication interfaces are selected from pairs of WiFi, Bluetooth, Near Field Communication (NFC), and radio frequency identification (RFID) interfaces.

6. The voice control system as claimed in claim 1, wherein said portable voice control device further includes a wearable body having said at least one audio pick-up unit and said output unit disposed thereon.

7. The voice control system as claimed in claim 6, wherein said wearable body is substantially U-shaped, and includes a curved segment and a pair of extending segments extending from two opposite ends of said curved segment.

8. The voice control system as claimed in claim 7, wherein said at least one audio pick-up unit is two in number, each of said audio pick-up units being disposed at a distal end of a respective one of said extending segments distal from said curved segment, said output unit being disposed on said curved segment.

9. The voice control system as claimed in claim 6, wherein said wearable body includes a head support segment, a pair of ear segments extending from two opposite ends of said head support segment, and an audio pickup holder extending from one of said ear segments, said output unit including two speakers disposed respectively at said ear segments, said audio pick-up unit being disposed at said audio pickup holder.

10. The voice control system as claimed in claim 6, wherein said portable voice control device further includes a power supply module disposed in said wearable body, and a universal serial bus (USB) charging slot disposed on said wearable body and coupled electrically to said power supply module for enabling charging of said power supply module via said USB charging slot.
